(19) United States
(12) Patent Application Publication
(10) Pub. No.: US 2013/0223304 A1
(43) Pub. Date: Aug. 29, 2013

(54) CORE NETWORK AND COMMUNICATION SYSTEM

(71) Applicants: Itsuma Tanaka, Kanagawa (JP); Kazuhito Tokunaga, Kanagawa (JP)

(72) Inventors: Itsuma Tanaka, Kanagawa (JP); Kazuhito Tokunaga, Kanagawa (JP)

(73) Assignee: NTT DOCOMO, INC., Tokyo (JP)

(21) Appl. No.: 13/883,845

(22) PCT Filed: Nov. 10, 2011
(86) PCT No.: PCT/JP2011/075896

§ 371 Date: May 7, 2013

(30) Foreign Application Priority Data
Nov. 12, 2010 (JP) 2010-254071

(51) Int. Cl. H04L 29/06

(52) U.S. Cl. CPC H04L 29/06013
USPC 370/310

(57) ABSTRACT

A core network connected to a mobile communication network and establishing voice communication between communication apparatuses receives, from the mobile communication network, to which an originating mobile communication apparatus is connected, a connection request that includes an identifier identifying a terminating communication apparatus, and determines at least one codec that can be used in a terminating network to which the terminating communication apparatus is connected. When the at least one codec that can be used in the terminating network can be used in the core network, the core network signals, to the originating mobile communication apparatus, that codec as a codec candidate that should be used by the originating mobile communication apparatus.

### TECHNICAL FIELD

The present invention relates to core networks and communication systems for establishing voice communication between communication apparatuses.

### BACKGROUND ART

In voice communication services using telephones, various codecs have been used. For example, the adaptive multi-rate wideband (AMR-WB) codec has been proposed as a codec for high-quality voice communication services. The AMR-WB, which is an improved version of the AMR codec currently used for telephones around the world, were standardized in 3GPP and are known as G.722.2 in ITU-T (see Non-Patent Documents 1 to 4). In the following description, the conventional AMR codec is called the adaptive multi-rate narrowband (AMR-NB) codec in order to differentiate it from the AMR-WB.

The transmission rate is 4.75 to 12.2 kbits/s in the AMR-NB, whereas the transmission rate in the AMR-WB is one of 12.65, 14.25, 15.85, 18.25, 19.85, 23.05, 23.85 kbits/s etc. The AMR-WB consumes a wider bandwidth than the AMR-NB.

Currently, the AMR-WB has been becoming dominant, but the codecs that can be used in networks depend on networks. For example, a network might use the AMR-WB and the AMR-NB, whereas another network might use only the AMR-NB.

When a mobile communication apparatus, such as a cell phone, performs voice communication with a communication apparatus (such as a fixed-line phone or a cell phone) connected to a communication network other than the mobile communication network to which the mobile communication apparatus subscribes, a core network that connects the mobile communication network to the communication network establishes voice communication between the communication apparatuses. As such a core network, the IP multimedia subsystem (IMS) for establishing voice over Internet protocol (VoIP) communication between communication apparatuses has been proposed (see Non-Patent Document 5). The IMS is also known as a multimedia domain (MMD).

### PRIOR ART DOCUMENTS

### Non-Patent Documents

Non-Patent Document 1: ITU-T Recommendation G.722.2; “Wideband coding of speech at around 16 kbits/s using Adaptive Multi-Rate Wideband (AMR-WB)”, International Telecommunication Union, July 2003
Non-Patent Document 2: 3GPP TS 26.190 V5.1.0 (2001-12), 3rd Generation Partnership Project; Technical Specification Group Services and System Aspects; Speech Codec speech processing functions; “AMR Wideband speech codec; Transcoding functions”, December 2001
Non-Patent Document 3: 3GPP TS 26.194 V5.0.0 (2001-03), 3rd Generation Partnership Project; Technical Specification Group Services and System Aspects; Speech Codec speech processing functions; “AMR Wideband speech codec; Voice Activity Detector (VAD)”, March 2001
Non-Patent Document 4: 3GPP TS 26.171 V5.0.0 (2001-03), 3rd Generation Partnership Project; Technical Specification Group Services and System Aspects; Speech Codec speech processing functions; “AMR Wideband speech codec; General Description”, March 2001
Non-Patent Document 5: 3GPP TS 23.228 V10.2.0 (2010-09), 3rd Generation Partnership Project; Technical Specification Group Services and System Aspects; “IP Multimedia Subsystem (IMS)”; Stage 2 (Release 10), September 2010

### SUMMARY OF INVENTION

### Technical Problems

For use of the INS, an originating mobile communication apparatus utilizes a common codec that belongs to the intersection of codecs that can be used by the originating mobile communication apparatus and codecs that can be supported by the media gateway control function (MGCF) of the IMS. When a codec to be used by the originating mobile communication apparatus is selected, codecs that can be used in the terminating network to which the terminating communication apparatus is connected are not taken into account. Therefore, when a mobile communication apparatus that can use both the AMR-WB and the AMR-NB originates a call in a network that can use the AMR-WB, the mobile communication apparatus uses the AMR-WB.

In that case, when the terminating apparatus is connected to a network that can only use the AMR-NB, the AMR-WB is used from the originating mobile communication apparatus to the media gateway (MGW) in the IMS core network, whereas the terminating network uses the AMR-NB. Even though the originating side uses the AMR-WB, which has a high transmission rate, since the terminating side uses the AMR-NB, which has a low transmission rate, voice eventually has low voice quality as a result of the AMR-NB. Thus, it is wasteful that the originating side consumes a wide bandwidth for the AMR-WB in light of the low voice quality which is finally obtained. Therefore, it is desirable that the wide bandwidth be reduced so that radio and core-network resources can be made available for communication performed by other users.

Accordingly, the present invention provides a core network and a communication system capable of using the bandwidth efficiently by matching, as closely as possible, the codec used at the originating side with the codec used at the terminating side.

### Solution to Problems

A core network according to the present invention is connected to a mobile communication network and establishes voice communication between communication apparatuses. The core network includes a connection-request receiver adapted for receiving, from the mobile communication network, to which an originating mobile communication apparatus is connected, a connection request that includes an identifier identifying a terminating communication apparatus or a terminating network; a termination-codec determination section adapted for determining, on the basis of the identifier included in the connection request, at least one codec that can be used in the terminating network to which the terminating communication apparatus is connected; and an available-codec signaling section adapted for signaling to the originating mobile communication apparatus, when the at least one codec that can be used in the terminating network, determined by the termination-codec determination section, can be used in the core network, that codec as a codec candidate that should be used by the originating mobile communication apparatus.

In the present invention, at least one codec that can be used in the terminating network is determined according to the identifier (such as the telephone number) of the terminating communication apparatus, which is included in the connection request received from the originating mobile communication apparatus, and, if that codec can be used in the core network, that codec is signaled to the originating mobile communication apparatus as a codec candidate that should be used by the originating mobile communication apparatus. For example, when the terminating network can use the AMR-NB only, and the core network can use both the AMR-WB and the AMR-NB, the AMR-NB is selected. By selecting the codec to be used for voice communication in the core network in a manner adapted to the terminating network as described above, the codec to be used at the originating side and the codec to be used at the terminating side can be matched as closely as possible. Therefore, the originating side uses the codec having a bandwidth suited to the voice quality to be obtained, so that the mobile communication network and the core network can use the bandwidth efficiently. In other words, the bandwidth required for the codec to be used at the originating side is reduced in conformity to the codec used at the terminating side, so that the radio and core-network resources can be made available for communication performed by others users.

When any of the at least one codec that can be used in the terminating network, determined by the termination-codec determination section, cannot be used in the core network, it is preferable that the available-codec signaling section signal a codec that can be used in the core network to the originating mobile communication apparatus as a codec candidate that should be used by the originating mobile communication apparatus.

According to this, when the codec that can be used in the terminating network cannot be used in the core network, voice communication between the originating mobile communication apparatus and the core network is possible with a codec that can be used in the core network.

If there is no common codec that belongs to the intersection of the codec (s) that can be used in the terminating network, determined by the termination-codec determination section, and codec (s) that can be used in the core network, the available-codec signaling section may preferably signal, to the originating mobile communication apparatus, a codec that has a transmission rate closest to the transmission rate of the codec that can be used in the terminating network, among the codecs that can be used in the core network. By doing so, the transmission rate of the codec to be used at the originating side is made close to the transmission rate of the codec used at the terminating side, reducing the bandwidth waste.

When there is a common codec that belongs to the intersection of a plurality of codecs that can be used by the originating mobile communication apparatus and the codec(s) signaled by the available-codec signaling section, the originating mobile communication apparatus specifies that common codec as the codec that should be used by the originating mobile communication apparatus. For example, when a plurality of codecs signaled by the available-codec signaling section are the same as the plurality of codecs that can be used in the originating mobile communication apparatus, the originating mobile communication apparatus may specify the best codec among them. More specifically, when both the AMR-WB and the AMR-NB are signaled by the available-codec signaling section, and both the AMR-WB and the AMR-NB can be used in the originating mobile communication apparatus, the mobile communication apparatus selects the AMR-WB. On the other hand, when a sole codec signaled by the available-codec signaling section is included in a plurality of codecs that can be used in the originating mobile communication apparatus, the originating mobile communication apparatus specifies the sole codec. More specifically, when only the AMR-NB is signaled by the available-codec signaling section, and both the AMR-WB and the AMR-NB can be used in the originating mobile communication apparatus, the originating mobile communication apparatus selects the AMR-NB.

It is preferable that the core network according to the present invention further include a codec-to-be-used-notification receiver adapted for receiving, from the originating mobile communication apparatus, a codec-to-be-used notification indicating a codec that is selected to be actually used by the originating mobile communication apparatus. By doing so, the core network can recognize the codec that is to be actually used by the originating mobile communication apparatus.

The core network according to the present invention is not limited to an IMS core network. However, if the core network according to the present invention is an IMS core network, it is preferable that a media gateway control function (MGCF) function as the termination-codec determination section and the available-codec signaling section. The reasons therefor are as follows: The MGCF belongs to the control plane (C-plane) in the IMS core network and is a physical connection point with another network. Since the MGCF knows the relationship between the terminating network that is connected to the IMS core network and a physical line connected to the terminating network, it is easy to provide the MGCF with the function of the termination-codec determination section, which determines one or more codecs that can be used in the terminating network connected. In addition, since the MGCF sends back to the originating mobile communication apparatus one or more codecs supported by the MGCF in response to the connection request from the originating mobile communication apparatus in accordance with the INS core network, which has already been proposed, it is easy to provide the MGCF with the function of the available-codec signaling section.

When the core network according to the present invention is an INS core network, a breakout gateway control function (BGCF) may function as the termination-codec determination section, and the MGCF may function as the available-codec signaling section. The reasons therefor are as follows: When some MGCFs, each of which is a physical connection point (i.e., a breakout point) with a circuit switching network in the IMS core network, which has already been proposed, are located in the IMS core network, the BGCF selects an MGCF suited to the terminating network. In other words, the BGCF has a routing function based on the telephone number of the terminating apparatus. Therefore, if the terminating network is a circuit switching network, since the BGCF knows the relationship between the connected terminating network and the MGCF that is suited thereto, it is easy to provide the BGCF with the function of the termination-codec determination section, which determines one or more codecs that can be used in the connected terminating network. In addition, since the MGCF sends back to the originating mobile communication apparatus one or more codecs supported by the MGCF in response to the connection request from the originating mobile communication apparatus in the IMS core network, which has already been proposed, it is easy to provide the MGCF with the function of the available-codec signaling section.

When the core network according to the present invention is an IMS core network, a serving call session control function (S-CSCF) may function as the termination-codec determination section, and the MGCF may function as the available-codec signaling section. The reasons therefor are as follows: In the IMS core network, which has already been proposed, the S-CSCF has a routing function based on the telephone number of the terminating apparatus. Therefore, the S-CSCF can determine the connected terminating network, so that it is easy to provide the S-CSCF with the function of the termination-codec determination section, which determines one or more codecs that can be used in the connected terminating network. In addition, since the MGCF sends back to the originating mobile communication apparatus one or more codecs supported by the MGCF in response to the connection request from the originating mobile communication apparatus in the IMS core network, which has already been proposed, it is easy to provide the MGCF with the function of the available-codec signaling section.

A communication system according to the present invention includes the above-described core network, a mobile communication network connected to the core network, and a mobile communication apparatus that connects to the mobile communication network. The mobile communication apparatus is adapted for sending the connection request to the core network. When the mobile communication apparatus is notified of a codec from the available-codec signaling section, the mobile communication apparatus is adapted for selecting a common codec that belongs to intersection of a plurality of codecs that can be used by the mobile communication apparatus and the codec signaled from the available-codec signaling section, as a codec that is to be actually used by the mobile communication apparatus, and is adapted for sending a codec-to-be-used notification indicating the selected codec to be used, to the core network.

By selecting the codec to be used for voice communication in the core network in a manner adapted to the terminating network, as described above, the codec to be used at the originating side and the codec to be used at the terminating side can be matched as closely as possible. In addition, since the mobile communication apparatus sends the codec-to-be-used notification to the core network, the core network can know the codec to be actually used by the originating mobile communication apparatus.

### BRIEF DESCRIPTION OF THE DRAWINGS

FIG. 1 is a block diagram showing the overall communication system according to embodiments of the present invention.

FIG. 2 is a view showing the structure of a database stored in a core network according to the embodiments of the present invention.

FIG. 3A is a part of a sequence diagram indicating an example information flow in a communication system according to a first embodiment of the present invention.

FIG. 3B is a part of the sequence diagram, following the part in FIG. 3A.

FIG. 3C is a part of the sequence diagram, following the part in FIG. 3B.

FIG. 4 is a part of a sequence diagram indicating an information flow in a communication system according to a second embodiment of the present invention.

FIG. 5 is a part of a sequence diagram indicating an information flow in a communication system according to a third embodiment of the present invention.

FIG. 6 is a part of a sequence diagram indicating an information flow in a communication system according to a fourth embodiment of the present invention.

### DESCRIPTION OF EMBODIMENTS

Various embodiments of the present invention will be described below with reference to the attached drawings.

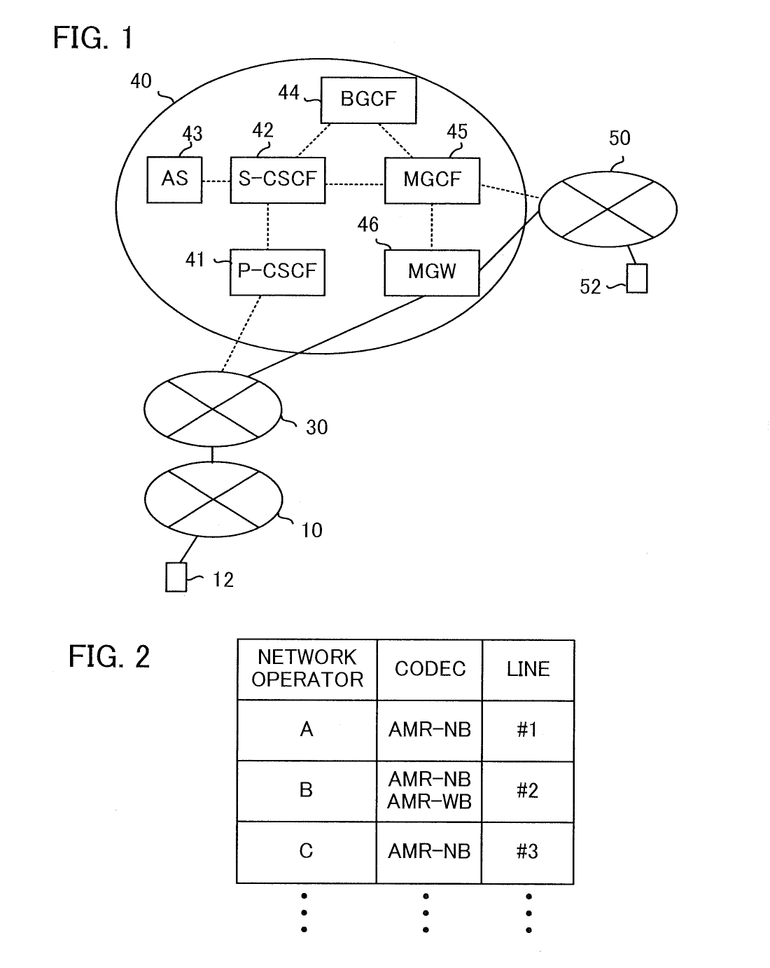

As shown in FIG. 1, a communication system according to embodiments of the present invention includes a mobile communication network 10, an evolved packet core (EPC) 30, and a core network 40. A large number of mobile communication apparatuses 12 are connected to the mobile communication network 10. The mobile communication apparatuses 12 are, for example, cell phones and other communication apparatuses having a voice communication function. The mobile communication network 10 conforms, for example, to long term evolution (LTE), but the specifications thereof are not limited to LTE. The EPC 30 manages the mobility of each of the mobile communication apparatuses 12. In the following description, the mobile communication apparatuses 12 may be called user equipments (UEs).

A plurality of external networks 50 are connected to the core network 40. The external networks 50 are circuit switching networks, such as public switched telephone networks (PSTNs) or public line mobile networks (PLMNs), or other networks (for example, networks conforming to SIP-I, in which ISUP messages are encapsulated within SIP messages and sent). A large number of communication apparatuses 52, such as cell phones or fixed-line telephones, are connected to each of the external networks 50. Therefore, the core network 40 establishes communication (including voice communication) between a mobile communication apparatus 12 connected to the mobile communication network 10 and capable of communicating via the IMS and a communication apparatus 52 connected to an external network 50.

The core network 40 is an IMS core network. The core network 40 includes various entities in addition to those shown in the figure, but includes the following main entities.

A proxy call session control function (P-CSCF) 41 is a session initiation protocol (SIP) router that receives SIP messages from the mobile communication apparatus 12 and sends SIP messages to the mobile communication apparatus 12.

A serving call session control function (S-CSCF) 42 is an SIP router providing the following functions:

Managing the registration information and the provided service information of users.

Managing user sessions.

Selecting an application server 43 that provides a service for each user.

The S-CSCF 42 also has a routing function based on the telephone numbers of terminating apparatuses.

The application server (AS) 43 provides a voice application by using SIP. In voice communication between users, the AS 43 provides, for example, additional services such as voice guidance.

A breakout gateway control function (BGCF) 44 also has a routing function based on the telephone numbers of terminating apparatuses. The BGCF 44 is used only for call origination from the INS to a communication apparatus connected to a circuit switching network, such as a PSTN or a PLMN. In other words, the BGCF 44 is used only when a call is originated to a communication apparatus 52 connected to an external network 50 that is a circuit switching network. When some MGCFs 45, each of which is a physical connection point (i.e., a breakout point) with a circuit switching network, are located in the IMS core network, the BGCF 44 selects an MGCF suited to the terminating network.

The media gateway control function (MGCF) 45 is a breakout point to a circuit switching network, in the IMS core network 40. The MGCF 45 handles C-plane control protocol conversion between the IMS core network 40 and the external network 50. Specifically, the MGCF 45 handles conversion between the SIP used in IMS control signals, and the ISDN user part (ISUP) or the bearer independent call control (BICC) used in control signals in a circuit switching network. The MGCF 45 controls the resources of a media gateway (MGW) 46 by using the H.248 protocol or the like.

The media gateway (MGW) 46 has an interface function for user data, such as voice, in the user plane (U-plane) when connected to the external network 50. Specifically, when the codec used from a mobile communication apparatus 12 to the core network 40 and the codec used in an external network 50 are not the same, the MGW performs code conversion between the codecs.

In FIG. 1, in the core network 40, dotted lines indicate the C-plane and solid lines indicate the U-plane. The U-plane is also called a media plane in the IMS.

### First Embodiment

It is assumed that a mobile communication apparatus 12 connected to the mobile communication network 10 and capable of communicating via the INS originates a call in order to perform voice communication with a communication apparatus 52 connected to an external network 50. The mobile communication apparatus 12 sends a connection request (SIP_INVITE) that includes an identifier (such as the telephone number) for identifying the terminating communication apparatus 52 and information indicating a plurality of codecs that can be used by the mobile communication apparatus 12. SIP_INVITE reaches the core network 40 through the mobile communication network 10 and the EPC 30 and is received by the P-CSCF (connection-request receiver) 41. SIP_INVITE is forwarded from the P-CSCF to the S-CSCF 42, and the S-CSCF (terminating-network determination section, termination-codec determination section) 42 determines the terminating external network 50 to which the terminating apparatus 52 is connected, on the basis of the identifier of the terminating communication apparatus 52. The S-CSCF 42 forwards SIP_INVITE to the BGCF 44 in order to connect to the determined terminating network. The BGCF 44 selects an appropriate MGCF 45 and forwards SIP_INVITE to the MGCF 45.

The MGCF (termination-codec determination section) 45 determines at least one codec that can be used in the terminating external network 50 to which the terminating communication apparatus 52 is connected, according to a database related to external networks. Specifically, the S-CSCF 42 and the MGCF 45 coordinate with each other to serve as a termination-codec determination section that determines at least one codec that can be used in the terminating external network 50, on the basis of the identifier of the terminating communication apparatus 52. When the at least one codec that can be used in the terminating external network 50, determined in this way, can also be used in the core network 40, the MGCF (available-codec signaling section) 45 signals the codec to the originating mobile communication apparatus 12 as a codec candidate that should be used by the originating mobile communication apparatus 12. In contrast, when the at least one codec that can be used in the terminating network cannot be used in the core network 40, the MGCF (available-codec signaling section) 45 signals, to the originating mobile communication apparatus 12, one or more codecs that can be used in the core network 40 to the originating mobile communication apparatus 12 as codec candidates that should be used by the originating mobile communication apparatus 12. An SIP_{—}183 message is used to signal the codec (s) that can be used.

For example, if the terminating network can use the AMR-NB only and the core network can use both the AMR-WB and the AMR-NB, the AMR-NB is selected. By selecting the codec to be used for voice communication in the core network in a manner adapted to the terminating network as described above, the codec to be used at the originating side and the codec used at the terminating side can be matched as closely as possible. Therefore, the originating side uses the codec having a bandwidth suited to the voice quality to be obtained, so that the mobile communication network and the core network can use the bandwidth efficiently. In other words, the bandwidth required for the codec to be used at the originating side is reduced in conformity to the codec used at the terminating side, so that the radio and core-network resources can be made available for communication performed by other users.

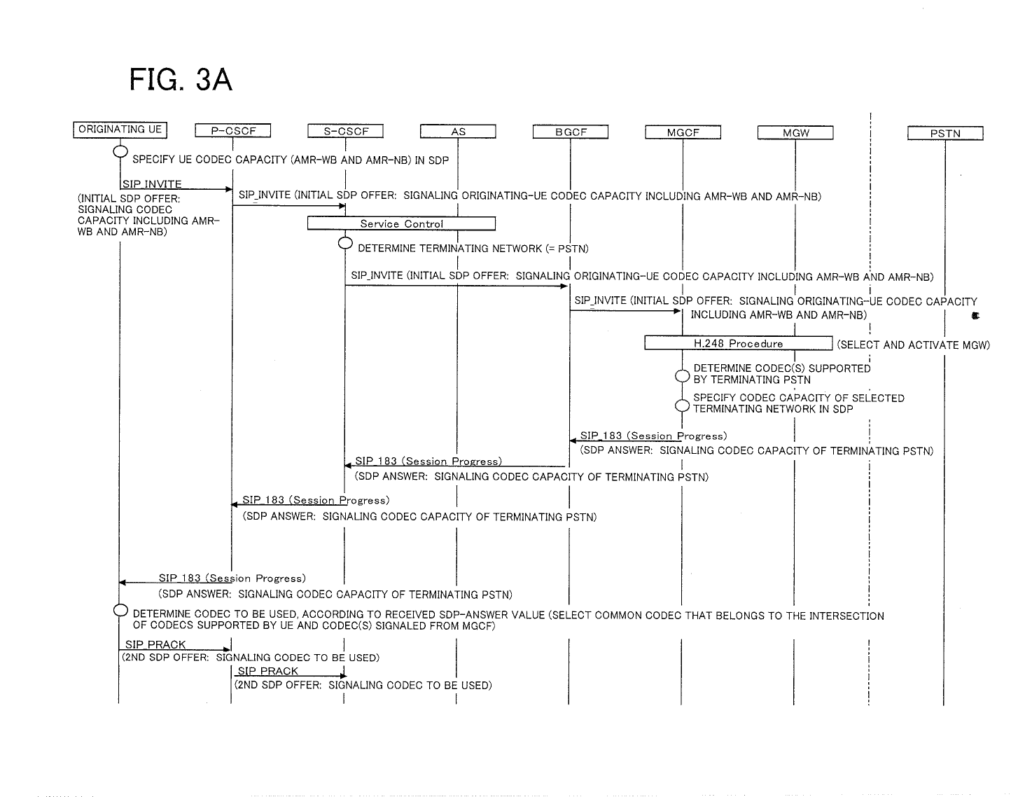

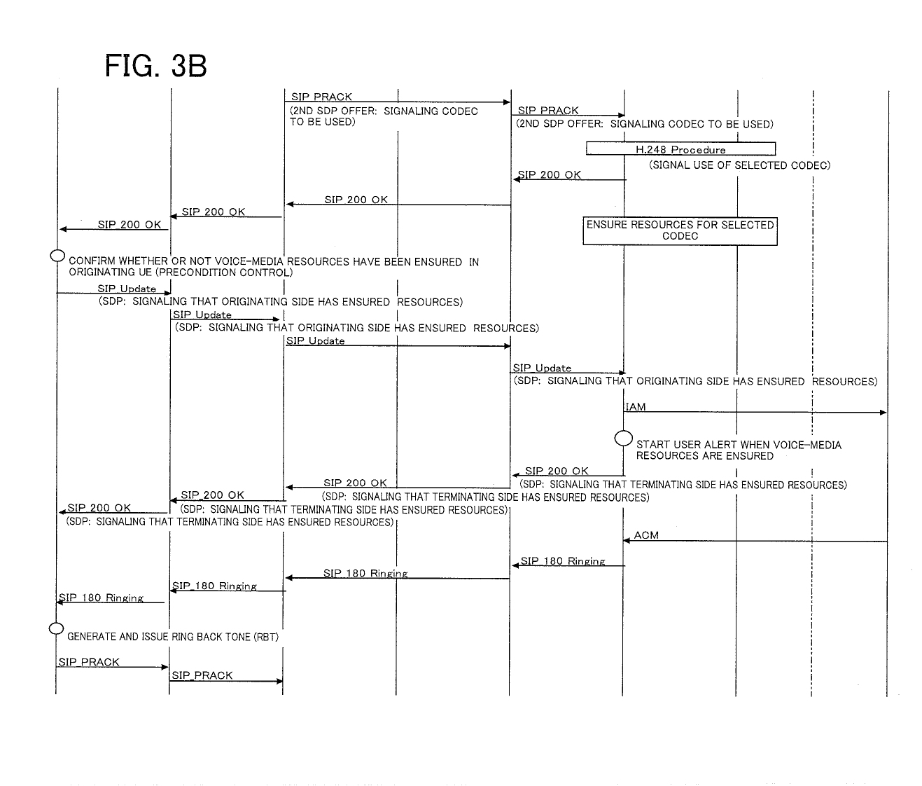

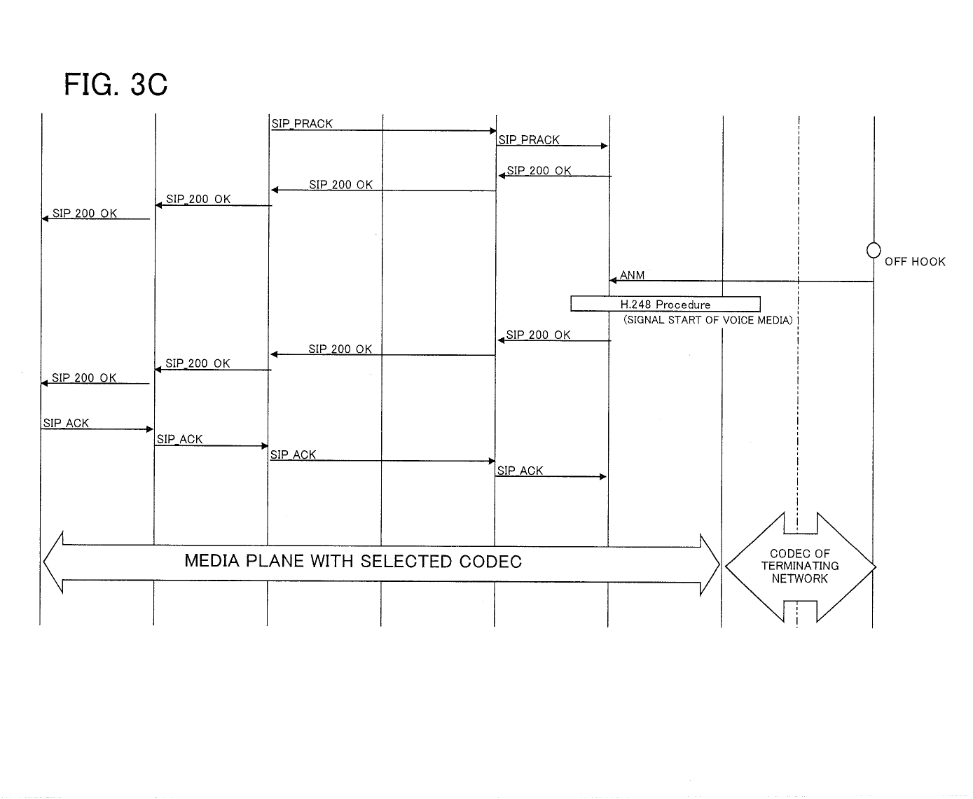

Upon receiving the notification of the codec(s) that can be used, the originating mobile communication apparatus 12 selects a common codec that belongs to the intersection of a plurality of codecs that can be used by the mobile communication apparatus 12 and the signaled codec(s), as the codec to be actually used by the mobile communication apparatus 12, and sends a codec-to-be-used notification (SIP_PRACK), indicating the selected codec to be used, to the core network (FIG. 3B).

For example, if the SIP_{—}183 message indicates that a plurality of codecs can be used, and those codecs are the same as a plurality of codecs that can be used in the originating mobile communication apparatus 12, the mobile communication apparatus 12 specifies the best codec among them. More specifically, if the SIP_{—}183 message indicates that both the AMR-WB and the AMR-NB can be used, and both the AMR-WB and the AMR-NB can also be used in the originating mobile communication apparatus 12, the mobile communication apparatus 12 selects the AMR-WB. On the other hand, if the SIP_{—}183 message indicates that only one codec can be used, and if that codec is included in a plurality of codecs that can be used in the originating mobile communication apparatus 12, the mobile communication apparatus 12 selects that one codec. More specifically, when the SIP_{—}183 message indicates that only the AMR-NB can be used, and both the AMR-WB and the AMR-NB can be used in the originating mobile communication apparatus 12, the mobile communication apparatus 12 selects the AMR-NB. In this manner, the codec that is to be actually used in the originating mobile communication apparatus 12 is fixedly decided.

The P-CSCF (codec-to-be-used-notification receiver) 41 receives the codec-to-be-used notification (SIP_PRACK) and forwards it to the MGCF 45. Upon receiving the codec-to-be-used notification (SIP_PRACK) the MGCF 45 uses the H.248 protocol to control the MGW 46 such that the MGW 46 ensures the resources required for the codec to be used by the originating mobile communication apparatus 12.

In the present embodiment, the MGCF 45 functions as the termination-codec determination section and the available-codec signaling section. The reasons therefor are as follows: The MGCF belongs to the C-plane in the IMS core network and is a physical connection point (i.e., breakout point) with another network. Since the MGCF knows the relationship between the terminating external network 50 that is connected to the IMS core network and the network operator, it is easy to provide the MGCF 45 with the function of the termination-codec determination section, which determines one or more codecs that can be used in the terminating external network 50 that is connected. In addition, since the MGCF sends back to the originating mobile communication apparatus 12 one or more codecs supported by the MGCF in response to the connection request (SIP_INVITE) from the originating mobile communication apparatus 12 in accordance with the IMS core network, which has already been proposed, it is easy to provide the MGCF with the function of the available-codec signaling section.

To function as the termination-codec determination section, the MGCF 45 stores a database shown in FIG. 2. This database indicates the relationship among network operators (in other words, networks operated by network operators), codecs that can be used in the networks operated by the network operators, and physical lines connected to the networks. Therefore, if the terminating network is determined, the MGCF 45 can determine the codec (s) that can be used in the network. The database shown in FIG. 2 is just an example, and the MGCF may have any form of data so long as the data describes the relationship between the networks and codecs.

An example information flow in the communication system according to the first embodiment will be described with reference to FIG. 3A to FIG. 3C. For convenience, the mobile communication network 10 and the EPC 30 are omitted from the figures. In the following description, it is assumed that the UE originates a call in order to perform voice communication with a communication apparatus 52 connected to an external network 50.

The telephone number of the communication apparatus 52 is input to the UE. The UE generates SIP_INVITE that includes Initial SDP Offer describing the UE codec capacity (codecs that can be used in the UE) according to the session description protocol (SDP). SIP_INVITE describes the telephone number of the communication apparatus 52 and the UE codec capacity (in this example, both the AMR-WB and the AMR-NB can be used in the UE). The reason for that SIP_INVITE describes the UE codec capacity is that it is requested by the IMS. The UE sends the generated SIP_INVITE to the P-CSCF, and the P-CSCF (connection-request receiver) transfers SIP_INVITE to the S-CSCF.

Upon receiving SIP_INVITE, the S-CSCF (terminating-network determination section, termination-codec determination section) requests the AS to perform service control, if necessary, and determines the terminating external network on the basis of the telephone number of the communication apparatus 52. In this example, the terminating network is a PSTN, but the terminating network may be another circuit switching network, such as a PLMN, or another type of network.

The S-CSCF transfers SIP_INVITE to the BGCF. The BGCF selects an MGCF suited to the PSTN, which is the terminating network, and transfers SIP_INVITE to the MGCF. The MGCF selects an MGW to be used for voice communication and uses the H.248 protocol to activate the MGW.

The MGCF (termination-codec determination section) determines at least one codec that can be used in the terminating network (that is, at least one codec supported by the terminating network), according to the terminating network. The MGCF further determines whether or not there is any common codec that belongs to the intersection of a plurality of codecs that can be used in the INS core network 40 and the codec(s) that can be used in the terminating network. If a common codec exists, the MGCF generates an SIP_{—}183 message (session progress) that includes SDP Answer describing the common codec (if there are a plurality of common codecs, all the codecs are described in SDP Answer). If no common codec exists, the MGCF generates an SIP_{—}183 message (session progress) that includes SDP Answer describing all the codecs that can be used in the IMS core network 40.

Alternatively, if no common codec exists, it is preferable that the MGCF generate an SIP_{—}183 message (session progress) that includes SDP Answer describing a codec that has a transmission rate closest to the transmission rate of one of the codecs that can be used in the terminating network, among all the codecs that can be used in the IMS core network 40. By doing so, the transmission rate of the codec to be used at the originating side is made close to the transmission rate of the codec used at the terminating side, reducing the bandwidth waste.

The MGCF (available-codec signaling section) sends the SIP_{—}183 message (session progress) to the originating UE. The SIP_{—}183 message (session progress) reaches the originating UE through the BGCF, the S-CSCF, and the P-CSCF. The UE decides, that is, selects, the codec that should be used, from the value of SDP Answer in the received SIP_{—}183 message (session progress). Specifically, the UE selects a common codec that belongs to the intersection of the codecs supported by the UE and the codec(s) signaled from the MGCF, as the codec to be actually used by the UE.

If the codec(s) signaled from the MGCF can be used in the IMS core network 40 and also in the terminating network, the codec to be actually used by the UE can also be used in the terminating network. If the codec(s) signaled from the MGCF can be used in the IMS core network 40 but cannot be used in the terminating network, the codec to be actually used by the UE cannot be used in the terminating network and is used between the UE and MGW only. In that case, the MGW performs code conversion between the codecs.

Next, the UE generates, according to the SDP, SIP_PRACK that includes 2nd SDP Offer indicating the selected codec to be used, which is a codec-to-be-used notification, and sends SIP_PRACK to the core network 40. SIP_PRACK is received by the P-CSCF (codec-to-be-used-notification receiver) and reaches the MGCF through the S-CSCF and the BGCF. The MGCF uses the H.248 protocol to signal to the MGW the codec to be actually used by the UE, and the MGW ensures the resources required for the codec.

The MGCF sends back SIP_{—}200 OK to the UE. Upon receiving SIP_{—}200 OK, the UE confirms whether or not voice-media resources have been ensured inside the UE (precondition control).

After the confirmation, the UE sends SIP_Update to the MGCF, which signals that the UE has ensured the resources. Upon receiving SIP_Update, the MGCF sends an ISUP initial address message (IAN) to the terminating external network 50. In other words, the MGCF requests the external network 50 to call the terminating communication apparatus 52. This IAM includes information indicating the codec to be actually used by the UE. If that codec can also be used in the terminating communication apparatus 52, it is expected that the communication apparatus 52 will use the codec.

When the core network 40 ensures voice-media resources for this voice communication, the MGCF starts USER ALERT, generates SIP_{—}200 OK for signaling that the terminating side has ensured the resources, and sends SIP_{—}200 OK to the UE.

Upon receiving an ISUP address complete message (ACM) from the terminating external network 50, the MGCF sends an SIP_{—}180 ringing message to the UE. This message indicates that the terminating apparatus is being called.

Upon receiving the SIP_{—}180 ringing message, the UE generates a ring back tone and issues it. The UE also sends SIP_PRACK to the MGCF, and the MGCF sends back SIP_{—}200 OK in response (FIG. 3C).

In the external network 50, when the communication apparatus 52 becomes off-hook in response to the calling, the external network 50 sends an answer message (ANM) to the MGCF. The MGCF signals to the MGW by using the H.248 protocol that the communication apparatus 52 became off-hook and voice-media communication has started. Then, the MGCF sends SIP_{—}200 OK to the UE, and the UE sends back SIP ACK in response.

### Second Embodiment

In the IMS core network 40, the BGCF 44 may determine one or more codecs that can be used in the terminating external network 50. In other words, the BGCF 44 may function as the termination-codec determination section. If some MGCFs, each of which is a physical connection point (i.e., a breakout point) with a circuit switching network are located in the IMS core network, which has already been proposed, the BGCF selects an MGCF suited to the terminating external network 50. In other words, the BGCF has a routing function based on the telephone number of the terminating apparatus. Therefore, if the terminating external network 50 is a circuit switching network, since the BGCF knows the relationship between the terminating external network 50 that is connected to the core network and the MGCF suited thereto, it is easy to provide the BGCF with the function of the termination-codec determination section, which determines one or more codecs that can be used in the terminating external network 50 that is connected.

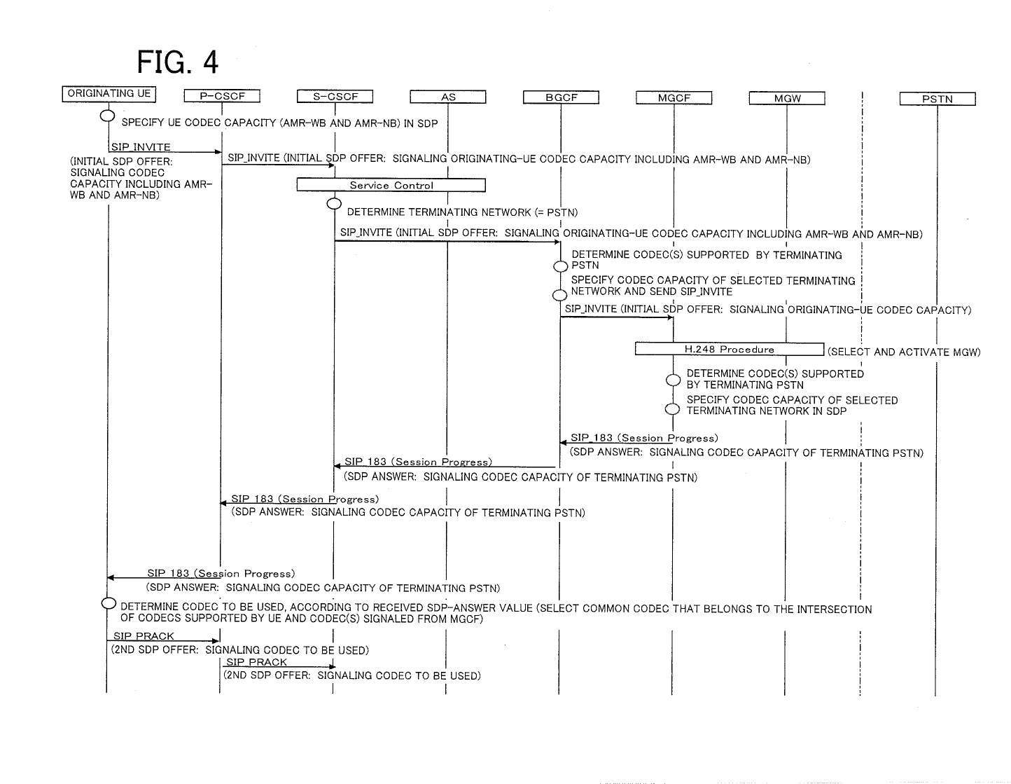

An example information flow in a communication system according to the second embodiment will be described with reference to FIG. 4. In the same way as in FIG. 3A to FIG. 3C, for convenience, the mobile communication network 10 and the EPC 30 are omitted from the figure. In the following description, it is assumed that the UE originates a call in order to perform voice communication with a communication apparatus 52 connected to an external network 50.

The telephone number of the communication apparatus 52 is input to the UE. The UE generates SIP_INVITE that includes Initial SDP Offer describing the UE codec capacity (codecs that can be used in the UE) according to the session description protocol (SDP). SIP_INVITE describes the telephone number of the communication apparatus 52 and the UE codec capacity (in this example, both the AMR-WB and the AMR-NB can be used in the UE). The reason for that SIP_INVITE describes the UE codec capacity is that it is requested by the IMS. The UE sends the generated SIP_INVITE to the P-CSCF, and the P-CSCF (connection-request receiver) transfers SIP_INVITE to the S-CSCF.

Upon receiving SIP_INVITE, the S-CSCF (terminating-network determination section, termination-codec determination section) requests the AS to perform service control, if necessary, and determines the terminating external network on the basis of the telephone number of the communication apparatus 52. In this example, the terminating network is a PSTN, but the terminating network may be another circuit switching network, such as a PLMN, or another type of network.

The S-CSCF transfers SIP_INVITE to the BGCF. The BGCF (termination-codec determination section) determines at least one codec that can be used in the terminating network (that is, at least one codec supported by the terminating network), according to the terminating network. The BGCF generates SIP_INVITE that describes this codec. When generating this SIP_INVITE, the BGCF may change the UE codec capacity described in Initial SDP Offer in the received SIP_INVITE to the codec capacity supported in the terminating network, or may add a new information element that describes the codec capacity supported in the terminating network to the received SIP_INVITE, separately from Initial SDP Offer that describes the UE codec capacity.

The BGCF selects an MGCF suited to the PSTN, which is the terminating network, and transfers SIP_INVITE generated by the BGCF to the MGCF. The MGCF selects an MGW to be used for this voice communication and uses the H.248 protocol to activate the MGW.

The MGCF further determines whether or not there is any common codec that belongs to the intersection of a plurality of codecs that can be used in the IMS core network 40 and the codec(s) that can be used in the terminating network. If a common codec exists, the MGCF generates an SIP_{—}183 message (session progress) that includes SDP Answer describing the common codec (if there are a plurality of common codecs, all the codecs are described in SDP Answer). If no common codec exists, the MGCF generates an SIP_{—}183 message (session progress) that includes SDP Answer describing all the codecs that can be used in the IMS core network 40.

Alternatively, if no common codec exists, it is preferable that the MGCF generate an SIP_{—}183 message (session progress) that includes SDP Answer describing a codec that has a transmission rate closest to the transmission rate of one of the codecs that can be used in the terminating network, among all the codecs that can be used in the IMS core network 40. By doing so, the transmission rate of the codec to be used at the originating side is made close to the transmission rate of the codec used at the terminating side, reducing the bandwidth waste.

The MGCF (available-codec signaling section) sends the SIP_{—}183 message (session progress) to the originating UE. The SIP_{—}183 message (session progress) reaches the originating UE through the BGCF, the S-CSCF, and the P-CSCF. The UE decides, that is, selects, the codec that should be used, from the value of SDP Answer in the received SIP_{—}183 message (session progress). Specifically, the UE selects a common codec that belongs to the intersection of the codecs supported by the UE and the codec (s) signaled from the MGCF, as the codec to be actually used by the UE.

If the codec (s) signaled from the MGCF can be used in the INS core network 40 and also in the terminating network, the codec to be actually used by the UE can also be used in the terminating network. If the codec (s) signaled from the MGCF can be used in the IMS core network 40 but cannot be used in the terminating network, the codec to be actually used by the UE cannot be used in the terminating network and is used between the UE and MGW only. In that case, the MGW performs code conversion between the codecs.

Next, the UE generates, according to the SDP, SIP_PRACK that includes 2nd SDP Offer indicating the selected codec to be used, which is a codec-to-be-used notification, and sends SIP_PRACK to the core network 40. SIP_PRACK is received by the P-CSCF (codec-to-be-used-notification receiver) and reaches the MGCF through the S-CSCF and the BGCF. The MGCF uses the H.248 protocol to signal to the MGW the codec to be actually used by the UE, and the MGW ensures the resources required for the codec.

The subsequent steps are the same as those described in the first embodiment with reference to FIG. 3B and FIG. 3C.

### Third Embodiment

In the INS core network 40, the S-CSCF 42 may determine one or more codecs that can be used in the terminating external network 50. In other words, the S-CSCF 42 may function as the termination-codec determination section. In the IMS core network, which has already been proposed, the S-CSCF has a routing function based on the telephone number of the terminating apparatus. Therefore, the S-CSCF can determine the terminating network that is connected to the core network, so that it is easy to provide the S-CSCF with the function of the termination-codec determination section, which determines one or more codecs that can be used in the terminating network that is connected.

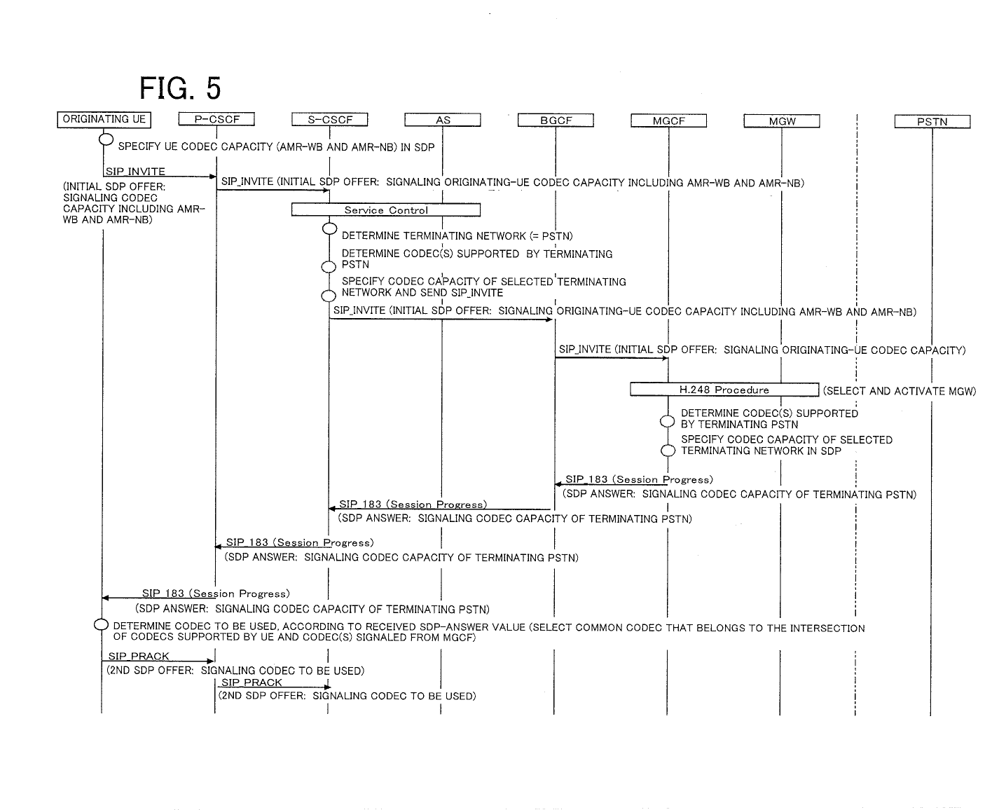

An example information flow in a communication system according to the third embodiment will be described with reference to FIG. 5. In the same way as in FIG. 3A to FIG. 3C, for convenience, the mobile communication network 10 and the EPC 30 are omitted from the figure. In the following description, it is assumed that the UE originates a call in order to perform voice communication with a communication apparatus 52 connected to an external network 50.

The telephone number of the communication apparatus 52 is input to the UE. The UE generates SIP_INVITE that includes Initial SDP Offer describing the UE codec capacity (codecs that can be used in the UE) according to the session description protocol (SDP). SIP_INVITE describes the telephone number of the communication apparatus 52 and the UE codec capacity (in this example, both the AMR-WB and the AMR-NB can be used in the UE). The reason for that SIP_INVITE describes the UE codec capacity is that it is requested by the IMS. The UE sends the generated SIP_INVITE to the P-CSCF, and the P-CSCF (connection-request receiver) transfers SIP_INVITE to the S-CSCF.

Upon receiving SIP_INVITE, the S-CSCF (terminating-network determination section, termination-codec determination section) requests the AS to perform service control, if necessary, and determines the terminating external network on the basis of the telephone number of the communication apparatus 52. In this example, the terminating network is a PSTN, but the terminating network may be another circuit switching network, such as a PLMN, or another type of network.

The S-CSCF determines at least one codec that can be used in the terminating network (that is, at least one codec supported by the terminating network), according to the terminating network. The S-CSCF generates SIP_INVITE that describes this codec. When generating this SIP_INVITE, the S-CSCF may change the UE codec capacity described in Initial SDP Offer in the received SIP_INVITE to the codec capacity supported in the terminating network, or may add a new information element that describes the codec capacity supported in the terminating network to the received SIP_INVITE, separately from Initial SDP Offer that describes the UE codec capacity. The S-CSCF sends SIP_INVITE generated in the S-CSCF to the BGCF.

The BGCF selects an MGCF suited to the PSTN, which is the terminating network, and transfers SIP_INVITE received from the S-CSCF 42 to the MGCF without change. The MGCF selects an MGW to be used for this voice communication and uses the H.248 protocol to activate the MGW.

The MGCF further determines whether or not there is any common codec that belongs to the intersection of a plurality of codecs that can be used in the IMS core network 40 and the codec(s) that can be used in the terminating network. If a common codec exists, the MGCF generates an SIP_{—}183 message (session progress) that includes SDP Answer describing the common codec (if there are a plurality of common codecs, all the codecs are described in SDP Answer). If no common codec exists, the MGCF generates an SIP_{—}183 message (session progress) that includes SDP Answer describing all the codecs that can be used in the IMS core network 40.

Alternatively, if no common codec exists, it is preferable that the MGCF generate an SIP_{—}183 message (session progress) that includes SDP Answer describing a codec that has a transmission rate closest to the transmission rate of one of the codecs that can be used in the terminating network, among all the codecs that can be used in the IMS core network 40. By doing so, the transmission rate of the codec to be used at the originating side is made close to the transmission rate of the codec used at the terminating side, reducing the bandwidth waste.

The MGCF (available-codec signaling section) sends the SIP_{—}183 message (session progress) to the originating UE. The SIP_{—}183 message (session progress) reaches the originating UE through the BGCF, the S-CSCF, and the P-CSCF. The UE decides, that is, selects, the codec that should be used, from the value of SDP Answer in the received SIP_{—}183 message (session progress). Specifically, the UE selects a common codec that belongs to the intersection of the codecs supported by the UE and the codec (s) signaled from the MGCF, as the codec to be actually used by the UE.

If the codec(s) signaled from the MGCF can be used in the IMS core network 40 and also in the terminating network, the codec to be actually used by the UE can also be used in the terminating network. If the codec(s) signaled from the MGCF can be used in the IMS core network 40 but cannot be used in the terminating network, the codec to be actually used by the UE cannot be used in the terminating network and is used between the UE and MGW only. In that case, the MGW performs code conversion between the codecs.

Next, the UE generates, according to the SDP, SIP_PRACK that includes 2nd SDP Offer indicating the selected codec to be used, which is a codec-to-be-used notification, and sends SIP_PRACK to the core network 40. SIP_PRACK is received by the P-CSCF (codec-to-be-used-notification receiver) and reaches the MGCF through the S-CSCF and the BGCF. The MGCF uses the H.248 protocol to signal to the MGW the codec to be actually used by the UE, and the MGW ensures the resources required for the codec.

The subsequent steps are the same as those described in the first embodiment with reference to FIG. 3B and FIG. 3C.

### Fourth Embodiment

In the IMS core network 40, the AS 43 may determine one or more codecs that can be used in the terminating external network 50. In other words, the AS 43 may function as the termination-codec determination section.

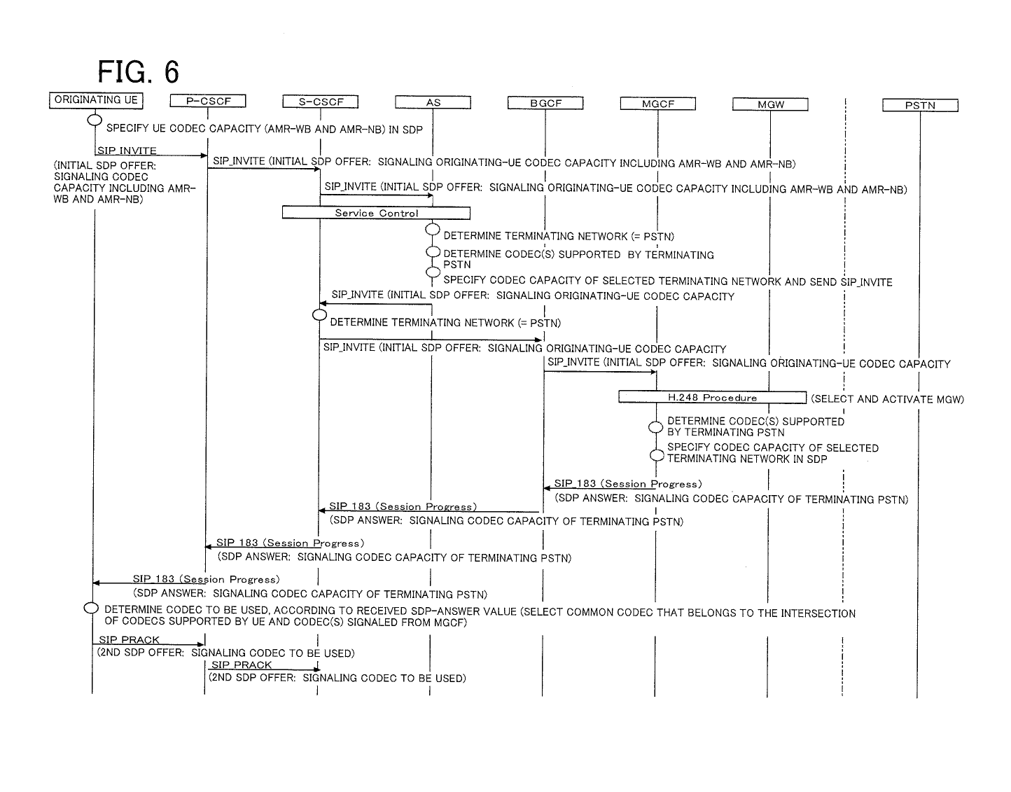

An example information flow in a communication system according to the fourth embodiment will be described with reference to FIG. 6. In the same way as in FIG. 3A to FIG. 3C, for convenience, the mobile communication network 10 and the EPC 30 are omitted from the figure. In the following description, it is assumed that the UE originates a call in order to perform voice communication with a communication apparatus 52 connected to an external network 50.

The telephone number of the communication apparatus 52 is input to the UE. The UE generates SIP_INVITE that includes Initial SDP Offer describing the UE codec capacity (codecs that can be used in the UE) according to the session description protocol (SDP). SIP_INVITE describes the telephone number of the communication apparatus 52 and the UE codec capacity (in this example, both the AMR-WB and the AMR-NB can be used in the UE). The reason for that SIP_INVITE describes the UE codec capacity is that it is requested by the IMS. The UE sends the generated SIP_INVITE to the P-CSCF, and the P-CSCF (connection-request receiver) transfers SIP_INVITE to the S-CSCF 42.

Upon receiving SIP_INVITE, the S-CSCF requests the AS to perform service control, if necessary, and also transfers that SIP_INVITE to the AS.

The AS (terminating-network determination section, termination-codec determination section) determines the terminating external network on the basis of the telephone number of the communication apparatus 52. In this example, the terminating network is a PSTN, but the terminating network may be another circuit switching network, such as a PLMN, or another type of network. The AS determines at least one codec that can be used in the terminating network (that is, at least one codec supported by the terminating network), according to the terminating network determined by the AS. The AS generates SIP_INVITE that describes this codec. When generating this SIP_INVITE, the AS 43 may change the UE codec capacity described in Initial SDP Offer in the received SIP_INVITE to the codec capacity supported in the terminating network, or may add a new information element that describes the codec capacity supported in the terminating network to the received SIP_INVITE, separately from Initial SDP Offer that describes the UE codec capacity. The AS 43 sends SIP_INVITE generated in the AS to the BGCF.

The S-CSCF also determines the terminating external network on the basis of the telephone number of the communication apparatus 52. In this example, the terminating network is a PSTN, but the terminating network may be another circuit switching network, such as a PLMN, or another type of network. The S-CSCF transfers SIP_INVITE generated in the AS to the BGCF without change.

The BGCF selects an MGCF suited to the PSTN, which is the terminating network, and transfers SIP_INVITE received from the S-CSCF 42 to the MGCF without change. The MGCF selects an MGW to be used for this voice communication and uses the H.248 protocol to activate the MGW.

The MGCF further determines whether or not there is any common codec that belongs to the intersection of a plurality of codecs that can be used in the IMS core network 40 and the codec(s) that can be used in the terminating network. If a common codec exists, the MGCF generates an SIP_{—}183 message (session progress) that includes SDP Answer describing the common codec (if there are a plurality of common codecs, all the codecs are described in SDP Answer). If no common codec exists, the MGCF generates an SIP_{—}183 message (session progress) that includes SDP Answer describing all the codecs that can be used in the IMS core network 40.

Alternatively, if no common codec exists, it is preferable that the MGCF generate an SIP_{—}183 message (session progress) that includes SDP Answer describing a codec that has a transmission rate closest to the transmission rate of one of the codecs that can be used in the terminating network, among all the codecs that can be used in the IMS core network 40. By doing so, the transmission rate of the codec to be used at the originating side is made close to the transmission rate of the codec used at the terminating side, reducing the bandwidth waste.

The MGCF (available-codec signaling section) sends the SIP_{—}183 message (session progress) to the originating UE. The SIP_{—}183 message (session progress) reaches the originating UE through the BGCF, the S-CSCF, and the P-CSCF. The UE decides, that is, selects, the codec that should be used, from the value of SDP Answer in the received SIP_{—}183 message (session progress). Specifically, the UE selects a common codec that belongs to the intersection of the codecs supported by the UE and the codec (s) signaled from the MGCF, as the codec to be actually used by the UE.

If the codec(s) signaled from the MGCF can be used in the IMS core network 40 and also in the terminating network, the codec to be actually used by the UE can also be used in the terminating network. If the codec(s) signaled from the MGCF can be used in the INS core network 40 but cannot be used in the terminating network, the codec to be actually used by the UE cannot be used in the terminating network and is used between the UE and MGW only. In that case, the MGW performs code conversion between the codecs.

Next, the UE generates, according to the SDP, SIP_PRACK that includes 2nd SDP Offer indicating the selected codec to be used, which is a codec-to-be-used notification, and sends SIP_PRACK to the core network 40. SIP_PRACK is received by the P-CSCF (codec-to-be-used-notification receiver) and reaches the MGCF through the S-CSCF and the BGCF. The MGCF uses the H.248 protocol to signal to the MGW the codec to be actually used by the UE, and the MGW ensures the resources required for the codec.

The subsequent steps are the same as those described in the first embodiment with reference to FIG. 3B and FIG. 3C.

Other Modifications

In the above-described embodiments, example codecs are the AMR-WB and the AMR-NB. Other codecs may be used in the communication system.

In the above-described embodiments, the core network 40 is an IMS core network. A core network according to the present invention is not limited to an IMS core network.

In the above-described embodiments, the identifier used to identify the terminating communication apparatus is the telephone number of the terminating communication apparatus. However, other identifiers may be used.

### REFERENCE NUMERALS

10: Mobile communication network
12: Mobile communication apparatus
30: EPC
40: Core network
41: P-CSCF (connection-request receiver, codec-to-be-used-notification receiver)
42: S-CSCF (termination-codec determination section)
43: AS (termination-codec determination section)
44: BGCF (termination-codec determination section)
45: MGCF (termination-codec determination section, available-codec signaling section)
46: MGW
50: External network
52: Communication apparatus

1. A core network connected to a mobile communication network and establishing voice communication between communication apparatuses, the core network comprising:
a connection-request receiver adapted for receiving, from the mobile communication network, to which an originating mobile communication apparatus is connected, a connection request that includes an identifier identifying a terminating communication apparatus or a terminating network;
a termination-codec determination section adapted for determining, on the basis of the identifier included in the connection request, at least one codec that can be used in the terminating network to which the terminating communication apparatus is connected; and
an available-codec signaling section adapted for signaling to the originating mobile communication apparatus, when the at least one codec that can be used in the terminating network, determined by the termination-codec determination section, can be used in the core network, that codec as a codec candidate that should be used by the originating mobile communication apparatus.

2. The core network according to claim 1, wherein, when any of the at least one codec that can be used in the terminating network, determined by the termination-codec determination section, cannot be used in the core network, the available-codec signaling section is adapted for signaling a codec that can be used in the core network to the originating mobile communication apparatus as a codec candidate that should be used by the originating mobile communication apparatus.

3. The core network according to claim 1, further comprising a codec-to-be-used-notification receiver adapted for receiving, from the originating mobile communication apparatus, a codec-to-be-used notification indicating a codec that is selected to be actually used by the originating mobile communication apparatus.

4. The core network according to claim 1, wherein the core network is an IP-multimedia-subsystem (IMS) core network; and
the core network comprises a media gateway control function (MGCF) functioning as the termination-codec determination section and the available-codec signaling section.

5. The core network according to claim 1, wherein the core network is an IP-multimedia-subsystem (IMS) core network; and
the core network comprises a breakout gateway control function (BGCF) functioning as the termination-codec determination section, and
a media gateway control function (MGCF) functioning as the available-codec signaling section.

6. The core network according to claim 1, wherein the core network is an IP-multimedia-subsystem (IMS) core network; and
the core network comprises a serving call session control function (S-CSCF) functioning as the termination-codec determination section, and
a media gateway control function (MGCF) functioning as the available-codec signaling section.

7. A communication system comprising:
the network according to claim 1;
a mobile communication network connected to the core network; and
a mobile communication apparatus that connects to the mobile communication network;
wherein the mobile communication apparatus is adapted for sending the connection request to the core network, and wherein when the mobile communication apparatus is notified of a codec from the available-codec signaling section, the mobile communication apparatus is adapted for selecting a common codec that belongs to intersection of a plurality of codecs that can be used by the mobile communication apparatus and the codec signaled from the available-codec signaling section, as a codec that is to be actually used by the mobile communication apparatus, and is adapted for sending a codec-to-be-used notification indicating the selected codec to be used, to the core network.
